(19) United States
(12) Patent Application Publication
(10) Pub. No.: US 2005/0265899 A1
(43) Pub. Date: Dec. 1, 2005

(54) Liquid transfer apparatus and method of manufacturing the same

(75) Inventors: Takeshi Imamura, Kanagawa-ken (JP); Takeo Yamazaki, Kanagawa-ken (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/522,404

(22) PCT Filed: Aug. 5, 2003
(86) PCT No.: PCT/JP03/09923

§ 371 Date: Jan. 26, 2005

(30) Foreign Application Priority Data
Aug. 6, 2002 (JP) NO. 2002-229244

(51) Int. Cl. G01N 3/00

(52) U.S. Cl. 422/100; 436/180

(57) ABSTRACT

A liquid transfer apparatus comprises a liquid containing section for containing liquid, a liquid introducing section for introducing liquid into the liquid containing section and a liquid leading out section for leading out the liquid introduced into the liquid containing section. When a number of such liquid transfer apparatuses are connected together, the liquid introducing section and the liquid leading out section of such liquid transfer apparatus are arranged such that the liquid leading out section of a liquid transfer apparatus communicates with the liquid introducing section of another liquid transfer apparatus.

### TECHNICAL FIELD

This invention relates to a liquid transfer apparatus for transferring a micro-volume of liquid in a micro-reactor that can suitably be used in a micro-total analysis system (μ-TAS).

### BACKGROUND ART

As a result of the development of three-dimensional micro-processing technologies in recent years, systems for chemical analysis to be conducted on a glass or silicon substrate, on which liquid handling elements such as micro-flow paths, pumps and valves are integrally formed with sensors, have been attracting attention. Such a system is called as miniaturized analysis system, μ-TAS (micro-total analysis system) or lab on a chip. With a downsized chemical analysis system, it is possible to remarkably reduce the ineffective volume and the volume of the specimen. It is also possible to reduce the analysis time and the power consumption of the entire system. Additionally, small systems may be marketed with low price tags. Thus, the μ-TAS is expected to find applications in the medical field including home medical care and bedside monitor and also in the biotechnological field including DNA analysis and proteome analysis because it is very small and can remarkably reduce the price and the analysis time.

Japanese Patent Application Laid-Open No. 10-337173 discloses a micro-reactor that allows to carry out a series of operations of mixing solutions, causing them to react each other, subsequently quantifying and analyzing the components and separating them in a biochemical experiment by means of a combination of several cells. FIG. 5 of the accompanying drawings is a schematic conceptual illustration of the disclosed micro-reactor 501. The micro-reactor 501 has an independent reaction chamber that is hermetically sealed with a flat plate on a silicon substrate. The micro-reactor 501 is formed by combining a reservoir cell 502, a mixing cell 503, a reaction cell 504, a detection cell 505 and a separation cell 506. A number of biochemical reactions can be conducted in parallel simultaneously by forming a number of such reactors on a substrate. Such micro-reactors can be used not only for analytic operations but also for substance synthesizing reactions including protein synthesizing reactions.

Japanese Patent Application Laid-Open No. 2001-158000 discloses a multifunctional device realized by using a micro-reactor. FIG. 9 of the accompanying drawings is an exploded schematic perspective view of a chemical reaction circuit formed by combining a plurality of chips having different respective single functions to produce a multilayer structure.

However, a number of problems arise when operating such a micro-reactor, which will be discussed below. Since the flow paths formed on the substrates have a very small diameter of tens of several μm to hundreds of several μm, they can easily become clogged as liquid of various different types is made to flow through them. Then as a result, there arises a problem of stains and the operation of restoring the original conditions to the device is a cumbersome one. Thus, when the micro-reactor is partly clogged or become inoperative, it has to be replaced by a new one because it is an integrated body of various components. Another problem is that, in a series of operations involving reactions using a micro-reactor, it is difficult to modify the composition of a reactive solution and/or other conditions of reaction on the way.

In the case of a chemical integrated circuit disclosed in the above cited Japanese Patent Application Laid-Open No. 2001-158000, while the microchips having different respective single functions can be separated from each other, any of them has to be replaced entirely when only a single part becomes inoperative out of a plurality of parts mounted on it and having a single function.

Finally, an electric technique such as one using electroendosmosis or one utilizing electrophoresis, and a mechanical technique such as a pump are conventionally employed as means for moving each liquid. However, the former technique has a drawback that the quantity and the flow rate of each liquid that is made to flow are remarkably influenced by the properties of the liquid and the operation of controlling them individually is very cumbersome, whereas the latter technique is accompanied by a problem that the pump is currently fitted to the outside to make the entire device bulky and liquid can leak from the connector connecting the pump and the related flow path.

### DISCLOSURE OF THE INVENTION

In view of the above identified circumstances, it is therefore the object of the present invention to provide a liquid transfer apparatus that can efficiently transfer and process a micro-volume of liquid and a method of manufacturing a liquid flow path device.

In an aspect of the invention, the above object is achieved by providing a liquid transfer apparatus comprising: a liquid containing section for containing liquid; a liquid introducing section for introducing liquid into said liquid containing section; and a liquid leading out section for leading out the liquid introduced into said liquid containing section, characterized in that said liquid introducing section and said liquid leading out section are arranged so as to make the liquid leading out section of a liquid transfer apparatus connect with the liquid introducing section of another liquid conveyor.

In another aspect of the invention, there is provided a method of manufacturing a liquid flow path device having a continuous liquid flow path by arranging a plurality of liquid transfer apparatuses side by side, each of said liquid transfer apparatuses comprising: a liquid containing section for containing liquid; a liquid introducing section for introducing liquid into said liquid containing section; and a liquid leading out section for leading out the liquid introduced into said liquid containing section, such that the liquid leading out section of a liquid conveyor communicates with the liquid introducing section of another liquid transfer apparatus.

In other words, the present invention provides a composite liquid transfer apparatus that can efficiently convey and process a micro-volume of liquid.

The problem of a stained device can hardly arise when a composite liquid transfer apparatus according to the invention is used because the flow path is formed basically only by liquid leading out sections and liquid introducing sections. Additionally, when a problem occurs to a liquid transfer apparatus in the composite device, only the liquid transfer apparatus in problem can be replaced easily and quickly restore the proper operation of the device. Furthermore, the composition of a reactive solution and/or other conditions of reaction can be modified by replacing one or more than one liquid transfer apparatuses on the way of a series of reactions.

### BRIEF DESCRIPTION OF THE DRAWINGS

FIG. 1 is a schematic view of an embodiment of liquid transfer apparatus according to the invention and comprising a heat generating element.

FIG. 2 is a schematic view of another embodiment of liquid transfer apparatus according to the invention and comprising a piezoelectric element.

FIG. 3 is a schematic view of a liquid transfer apparatus formed by connecting six liquid transfer apparatuses according to the invention.

FIG. 4 is a schematic perspective view of the composite liquid transfer apparatus of FIG. 3.

FIG. 5 is a schematic view of a known micro-reactor.

FIG. 6 is a schematic cross sectional view of a heat generating element that is adapted to be used in an embodiment of the invention.

FIGS. 7A, 7B, 7C, 7D, 7E, 7F, 7G and 7H are schematic views of a connecting/disconnecting section of a liquid conveyor according to the invention.

FIG. 8 is a schematic view of a composite liquid conveyor used in the example according to the invention.

FIG. 9 is a schematic view of a known micro-reactor.

### BEST MODE FOR CARRYING OUT THE INVENTION

Now, the present invention will be described in greater detail.

According to the invention, there is provided a liquid transfer apparatus comprising: a liquid containing section for containing liquid; a liquid introducing section for introducing liquid into said liquid containing section; and a liquid leading out section for leading out the liquid introduced into said liquid containing section; characterized in that said liquid introducing section and said liquid leading out section are arranged so as to make the liquid leading out section of a liquid transfer apparatus communicate with the liquid introducing section of another liquid conveyor.

A liquid transfer apparatus according to the invention may comprise a plurality of liquid introducing sections and a plurality of liquid leading out sections.

Each liquid transfer apparatus constituting a composite liquid conveyor according to the invention may comprise at least a processing means for heating, condensing, agitating, mixing or causing a chemical or biochemical reaction of the liquid ejected from said liquid introducing section into said liquid containing section in the latter.

Preferably, each liquid conveyor of a composite liquid conveyor according to the invention is provided with a check valve arranged at the ejection port to prevent the ejected liquid from flowing back.

The liquid leading out section of each liquid conveyor of a liquid processing device according to the invention is provided with an energy applying means as means for ejecting liquid. Preferably, a thermal jet system that is characterized by utilizing energy of expanding bubbles generated by rapidly heating the liquid with a heat generating element or a piezo jet system characterized by utilizing energy generated by a vibrator plate stacked with a plate-shaped piezoelectric element to apply pressure on the liquid leading out section may be used for applying energy in order to eject liquid.

A liquid transfer method according to the invention is characterized by comprising a step of removably connecting to unite a plurality of liquid conveyors, each comprising a liquid containing section for containing liquid, a liquid introducing section for introducing liquid into said liquid containing section and a liquid leading out section for leading out the liquid introduced into said liquid containing section, and a step of transfering liquid from the liquid introducing section of a liquid conveyor to the liquid leading out section of another liquid transfer apparatus by ejecting the liquid contained in the liquid containing section of the former liquid transfer apparatus.

A liquid flow path device according to the invention is characterized by comprising a plurality of liquid transfer apparatuses arranged side by side, each having a liquid containing section for containing liquid, a liquid introducing section for introducing liquid into said liquid containing section and a liquid leading out section for leading out the liquid introduced into said liquid containing section, such that the liquid leading out section of a transfer apparatus connects with the liquid introducing section of another transfer apparatus to form a liquid flow path continuing from the liquid introducing section of the former liquid transfer apparatus to the liquid leading out section of the latter liquid transfer apparatus.

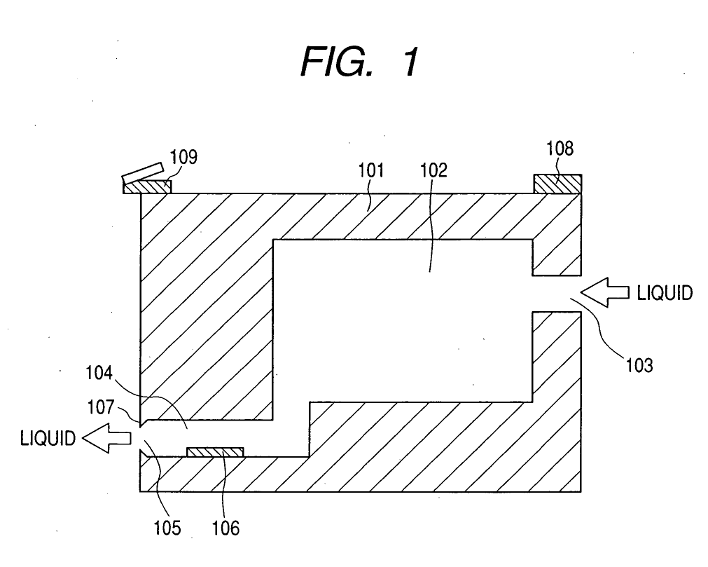

FIG. 1 is a schematic conceptual illustration of an embodiment of a liquid transfer apparatus that is to be used as a unit of a liquid flow path device according to the invention. It is a thermal ink-jet system type liquid transfer apparatus having a heat generating element for generating thermal energy that causes liquid to give rise to film boiling as energy to be used for ejecting liquid.

The liquid transfer apparatus of FIG. 1 comprises a liquid containing section 102, a liquid introducing section 103 and a liquid leading out section 104 formed integrally on a base member 101. The liquid leading out section has an ejection port 105 through which liquid is ejected, a heat generating element 106 that generates energy necessary for ejecting liquid and a check valve 107 that prevents ejected liquid from flowing back. Liquid is transfered from the liquid introducing section 103 to the liquid containing section 102 and ejected through the ejection port 105 of the liquid leading out section 104. The ejection port of each liquid transfer apparatus can be made to communicate with the liquid introducing section of the immediately downstream liquid transfer apparatus. Then, liquid ejected from the ejection port of the former liquid transfer apparatus is conveyed to the liquid introducing section of the latter liquid transfer apparatus. Although not shown, at least either the ejection port or the liquid introducing section has a sealing member (e.g., O-ring) for improving the liquid-tightness of them.

The liquid introduced from the liquid introducing section 103 into the liquid containing section 102 may be subjected to a processing operation of heating, condensing, agitating, mixing or causing a chemical or biochemical reaction there. For this purpose, the liquid containing section 102 may be provided with an element that promotes the processing operation. For example, the liquid containing section 102 may have a heat generating element in order to heat and agitate the introduced liquid.

The liquid containing section 102 may contain liquid before additional liquid is introduced from the liquid introducing section 103. Then, both the liquid that is already in the liquid containing section 102 and the newly introduced liquid may be subjected to a processing operation of heating, condensing, agitating, mixing or causing a chemical or biochemical reaction in it.

A liquid transfer apparatus according to the invention may comprise a plurality of each section formed on a same base member. Particularly, when liquids of different types are introduced from respective liquid introducing sections 103 into a single liquid containing section 102, the liquids can be collectively subjected to a processing operation of heating, condensing, agitating, mixing or causing a chemical or biochemical reaction in the liquid containing section 102.

The base member is provided with a connection/disconnection recess 108 and a connection/disconnection projection 109 for reversibly connecting liquid processing devices.

The position of each section on the base member of a liquid transfer apparatus according to the invention is not particularly limited so long as it does not significantly adversely affect the mechanical strength of the device. Therefore, it may be selected so as to optimize the operation of the liquid processing device comprising it as will be described hereinafter.

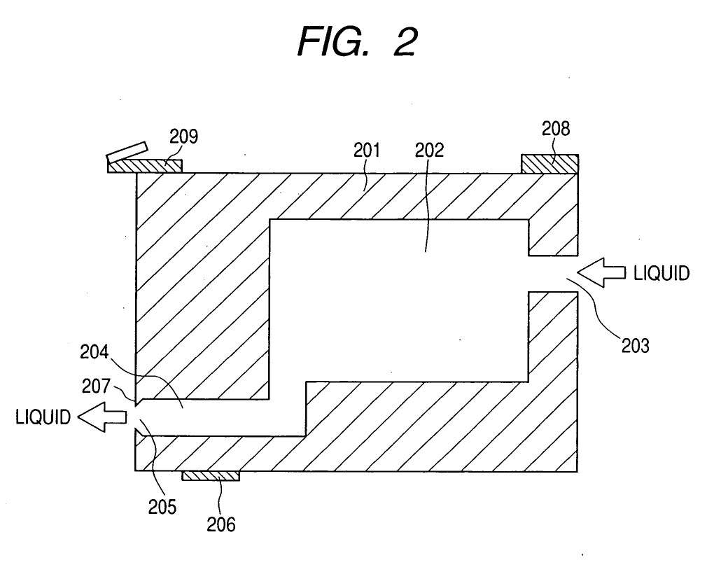

FIG. 2 is a schematic conceptual illustration of another embodiment of a liquid transfer apparatus that is to be used as a unit of a liquid flow path device according to the invention. It is a piezo ink-jet system type liquid transfer apparatus having a vibrator plate stacked with a plate-shaped piezoelectric element to apply pressure on the liquid leading out section as energy to be used for ejecting liquid. While the profile of the piezoelectric element is not subjected to any particular limitations, it is preferably plate-shaped from the viewpoint of downsizing the liquid transfer apparatus.

The liquid transfer apparatus of FIG. 2 comprises a liquid containing section 202, a liquid introducing section 203 and a liquid leading out section 204 formed integrally on a substrate 201. The liquid leading out section has an ejection port 205 through which liquid is ejected, a piezoelectric element 206 that generates energy necessary for ejecting liquid and a check valve 207 that prevents ejected liquid from flowing back. As a matter of fact, the base member operates as vibrator plate in an area where the piezoelectric element 206 is held in contact. Liquid is transferred from the liquid introducing section 203 to the liquid containing section 202 and ejected from the ejection port 205 of the liquid leading out section 204.

The liquid introduced from the liquid introducing section 203 into the liquid containing section 202 may be subjected to a processing operation of heating, condensing, agitating, mixing or causing a chemical or biochemical reaction there. For this purpose, the liquid containing section 202 may have an element that promotes the processing operation. For example, the liquid containing section 202 may be provided with a heat generating element in order to heat and agitate the introduced liquid.

The liquid containing section 202 may contain liquid before additional liquid is introduced from the liquid introducing section 203. Then, both the liquid that is already in the liquid containing section 202 and the newly introduced liquid may be subjected to a processing operation of heating, condensing, agitating, mixing or causing a chemical or biochemical reaction in it.

A liquid transfer apparatus according to the invention may comprise a plurality of each section formed on a same base member. Particularly, when liquids of different types are introduced from respective liquid introducing sections 203 into a single liquid containing section 202, the liquids can be collectively subjected to a processing operation of heating, condensing, agitating, mixing or causing a chemical or biochemical reaction in the liquid containing section 202.

The substrate is provided with a connection/disconnection recess 208 and a connection/disconnection projection 209 for removably connecting liquid processing devices.

The position of each section on the substrate of a liquid transfer apparatus according to the invention is not particularly limited so long as it does not significantly adversely affect the mechanical strength of the device. Therefore, it may be selected so as to optimize the operation of the liquid processing device comprising it as will be described hereinafter.

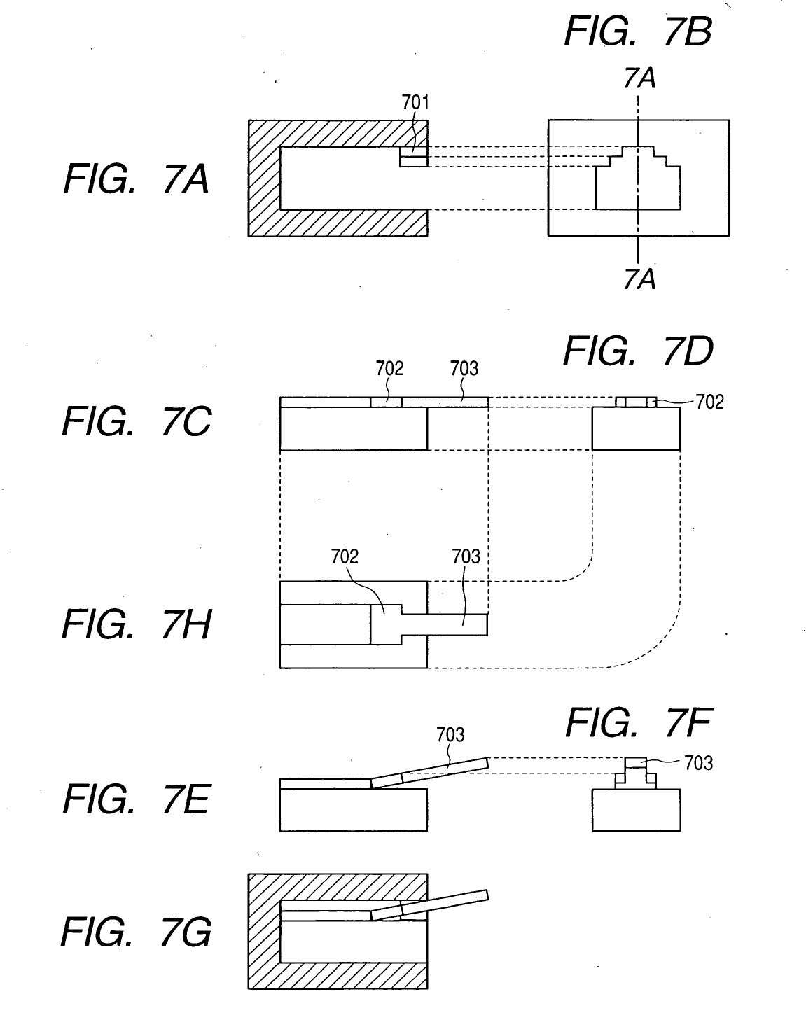

FIGS. 7A through 7H are schematic views of a connecting/disconnecting section of an embodiment of liquid transfer apparatus according to the invention, although the present invention is by no means limited thereto. FIG. 7B is a schematic front view of the connection/disconnection recess and FIG. 7A is a schematic cross sectional view taken along plane 7A-7A in FIG. 7B. On the other hand, FIG. 7D is a schematic front view of the connection/disconnection projection to be received in the connection/disconnection recess and FIG. 7C is a schematic lateral view of the projection. FIG. 7F is a schematic front view of the connection/disconnection projection when it is inserted into the connection/disconnection recess. FIG. 7E is a schematic lateral view of the projection corresponding to FIG. 7F. FIG. 7G is a schematic conceptual cross sectional view showing the recess and the projection that are put together. As seen from FIGS. 7C and 7D, the part 702 of the connection/disconnection projection is linked to the part 703 that is depressed downward by applying pressure thereto when the connection/disconnection projection is inserted into the connection/disconnection recess so that it may be safely and smoothly inserted into the recess through the inlet port of the latter. As the pressure being applied to the part 703 is released after the insertion, the resilient part 703 rises upward to restore the original profile as shown in FIG. 7E. As a result, the part 702 also rises upward. Since the part 702 has a width greater than that of the part 703 as shown in FIG. 7H, the connection is rigidly secured by the part 701 shown in FIG. 7A in a manner as illustrated in FIG. 7G. The projection and the recess are disconnected easily from each other when the part 703 is depressed downward by applying pressure thereto.

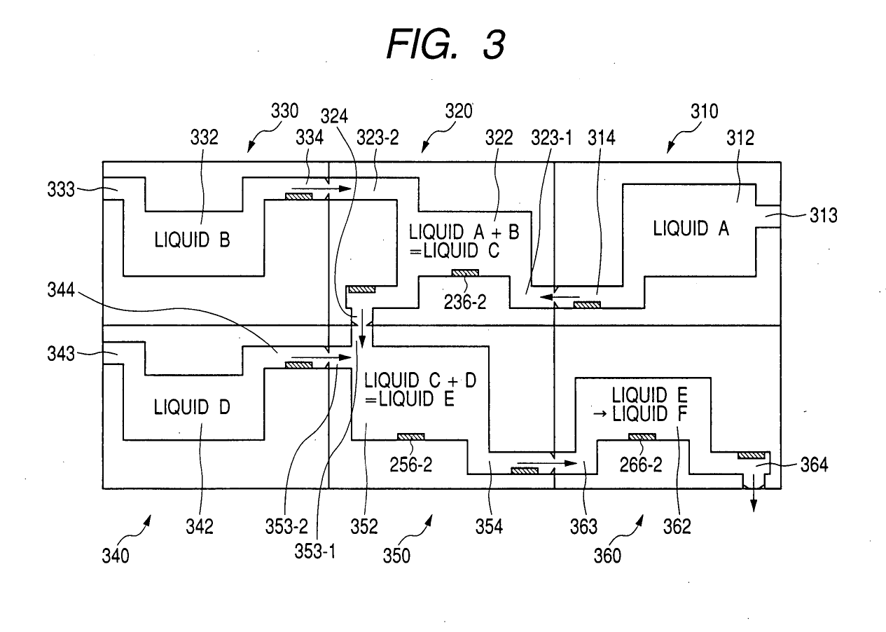

FIG. 3 is a schematic conceptual illustration of an embodiment of liquid processing device formed by connecting six thermal ink-jet system type liquid transfer apparatuses (liquid transfer apparatuses 310, 320, 330, 340, 350, 360) according to the invention, each comprising a heat generating element for generating thermal energy that causes liquid to give rise to film boiling as energy to be used for ejecting liquid.

Referring to FIG. 3, liquid A introduced from the liquid introducing section 313 of the liquid transfer apparatus 310 is contained in the liquid containing section 312 and then introduced into the liquid introducing section 323-1 of the liquid transfer apparatus 320 from the liquid leading out section 314 at a desired rate and at a desired frequency. On the other hand, liquid B introduced from the liquid introducing section 333 of the liquid transfer apparatus 330 is contained in the liquid containing section 332 and then introduced into the liquid introducing section 323-2 of the liquid transfer apparatus 320 from the liquid leading out section 334 at a desired rate and at a desired frequency. In the liquid transfer apparatus 320, the liquid A and the liquid B introduced respectively from the liquid introducing section 323-1 and the liquid introducing section 323-2 are contained in the liquid containing section 322 and heated/agitated to react with each other and become liquid C at the original position by a heat generating element denoted by 236-2.

Liquid C is introduced into the liquid introducing section 353-1 of the liquid transfer apparatus 350 from the liquid leading out section 324 at a desired rate and at a desired frequency. On the other hand, liquid D introduced from the liquid introducing section 343 of the liquid transfer apparatus 340 is contained in the liquid containing section 342 and then introduced into the liquid introducing section 353-2 of the liquid transfer apparatus 350 from the liquid leading out section 344 at a desired rate and at a desired frequency. In the liquid transfer apparatus 350, the liquid C and the liquid D introduced respectively from the liquid introducing section 353-1 and the liquid introducing section 353-2 are contained in the liquid containing section 352 and heated/agitated to react with each other and become liquid E at the original position by a heat generating element denoted by 256-2.

Liquid E is introduced into and contained in the liquid containing section 362 by way of the liquid introducing section 363 of the liquid transfer apparatus 360 from the liquid leading out section 354 at a desired rate and at a desired frequency, where it is heated/agitated by a heat generating element denoted by 266-2 to give rise to a chemical change and become liquid F at the original position. Liquid F is then conveyed from the liquid leading out section 364 to a subsequent step, which may be a separation/refinement step or a detection step, at a desired rate and at a desired frequency. Methods that can be used for the detection step include an electrochemical detection method and a detection method that utilizes fluorescence.

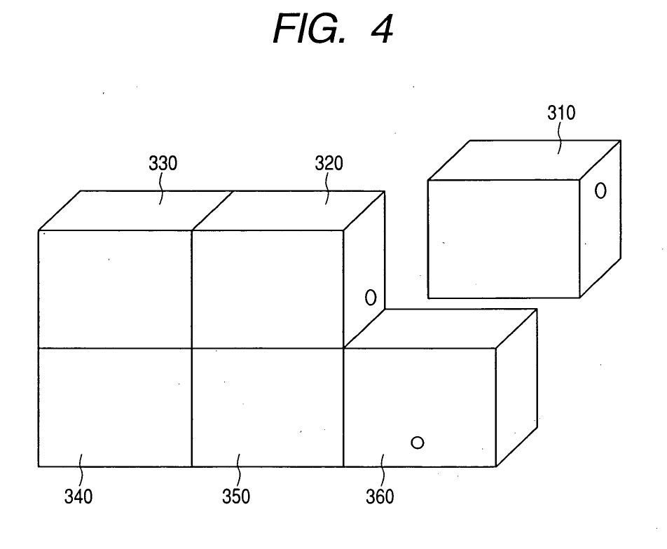

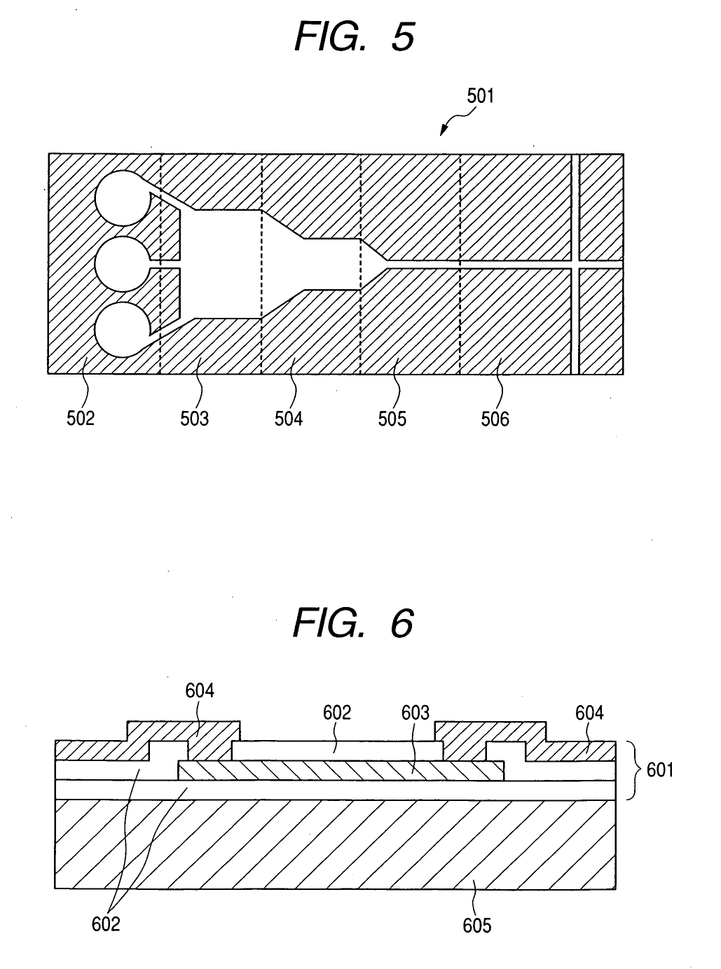

FIG. 4 is a schematic perspective view of the embodiment of liquid processing device according to the invention shown in FIG. 3. As seen from FIG. 4, each liquid transfer apparatus is realized as an independent unit that is like a cassette and can be connected to and disconnected from other liquid transfer apparatuses. With such an arrangement, each unit can be replaced quickly depending on the reaction to be conducted. Additionally, if a unit is clogged or becomes the cause of stain, it can also be replaced quickly to restore the ongoing reaction system.

FIG. 6 is a schematic cross sectional view of a heat generating element that is adapted to be used in an embodiment of the invention. The heat generating element 601 is formed on a substrate 605 by sandwiching a thin film resistor 603 between a pair of protection layers 602 of an insulating material from above and below. Materials that can be used for the thin film resistor 603 include metal materials such as Ta and semiconductor materials such as silicon that is made electrically conductive. The protection layers 602 can protect the surfaces of the thin film resistor against chemical reactions. Materials that can be used for the protection layers 602 include insulating materials such as SiO₂ and Si₃N₄. The opposite ends of the thin film resistor are electrically connected to respective electrodes 604 by way of respective contact holes formed in one of the protection layers 602. Thus, the heat generating element can be heated by applying a voltage between the opposite ends of the thin film resistor by way of the electrodes 604.

While a method of ejecting liquid by means of a heat generating element is described above, liquid can be ejected alternatively by means of a piezoelectric element or an electrostatic actuator that is popularly used in a known ink-jet head.

As described above, since the flow path of a liquid flow path device according to the invention is formed basically by liquid leading out sections and liquid introducing sections, the stain problem can hardly take place and, if a problem arises, the ongoing operation of the device can be restored easily and quickly by replacing the transfer apparatus(es) where the problem takes place. Additionally, since any of the liquid transfer apparatuses of a liquid flow path device can be replaced during a series of reactions, it is possible to change the composition and/or the conditions of reaction of a reaction liquid. Furthermore, since the liquid leading out section of each liquid transfer apparatus is provided with a means for moving liquid as functional feature of producing an ink jet, it is easy to control the operation of the liquid transfer apparatus and downsize the device.

Now, the present invention will be described further by way of an example. Note that the dimensions, the profiles, the materials and the conditions of reaction are cited only for the sake of easy understanding in the description of the example and may be altered appropriately so long as the requirements of the invention are met.

### EXAMPLE 1

Observation of Activity of Carnitine Palmitoyl Transferase in the Liver of a Rat

A part (about 3 g) of the liver of a rat that is cleaned with physiological saline is homogenized by means of a homogenizing buffer solution (3 mM tris-HCl (pH 7.2) containing 0.25M sucrose and 1 mM EDTA) and centrifuged by 500×g for 10 minutes (4° C.). The obtained supernatant is transferred to another centrifuge tube and centrifuged by 9,000×g for 10 minutes (4° C.) to obtain a specimen as supernatant. Note that “M” represents the concentration expressed by “mol/l”.

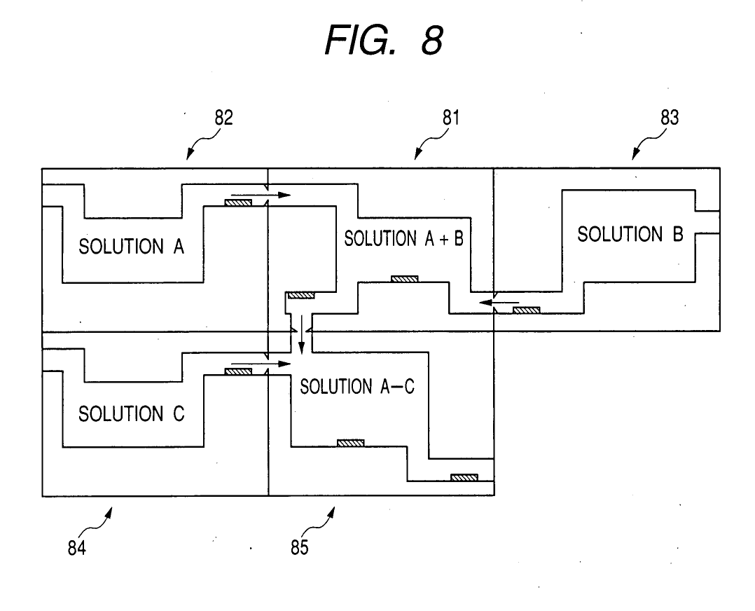

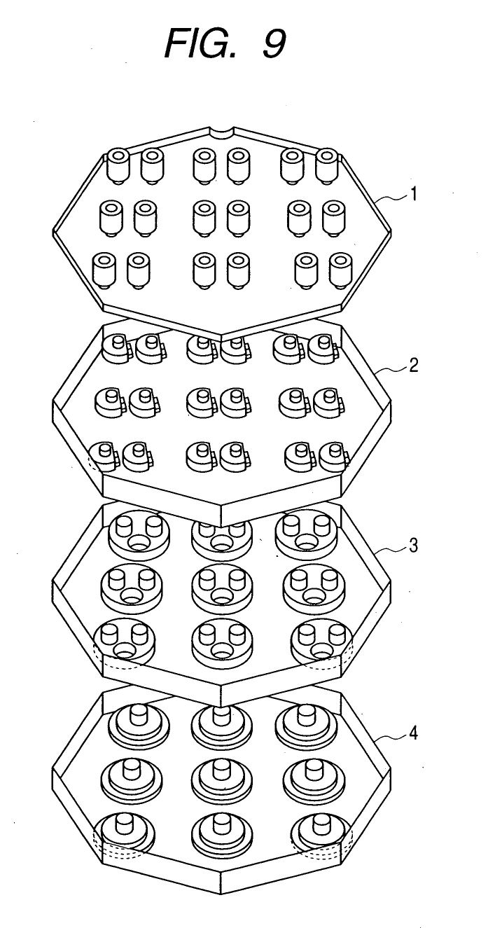

As solvent, a buffer solution (16 mM tris-HCl buffer, 2.5 mM EDTA, 0.2% Triton X-100 (tradename: available from Kishida Chemical Co., pH 8.0, 0.5 ml) was added to the specimen with 0.005 ml of a source of enzyme, to which water is added to make the final volume equal to 0.97 ml. The mixture is mixed well and 100 μl of the mixture is introduced into a liquid transfer apparatus 81 whose temperature is held to 30° C. Note that a liquid flow path device as shown in FIG. 8 was used in this example. Apart from this, 10 μl of the specimen is introduced into another liquid transfer apparatus 82 and 100 μl aqueous solution of 5 mM DTNB (5,5′-dithiobis(2-nitrobenzoate)) is introduced into still another liquid transfer apparatus 83. Furthermore, 100 μl of 80 μM palmitoyl-CoA solution (tradename: available from SIGMA Co.) is introduced into still another liquid transfer apparatus 84. Still another liquid transfer apparatus 85 whose liquid containing section is vacant is also brought in.

As shown in FIG. 8, the liquid transfer apparatus 81 that has two liquid inlet ports is combined with the liquid transfer apparatuses 82 and 83 in such a way that the liquid inlet ports are aligned respectively with the ejection ports of the liquid transfer apparatuses 82 and 83. The liquid transfer apparatus 85 also has two liquid inlet ports and all the five liquid transfer apparatuses are combined in such a way that the two liquid inlet ports of the liquid transfer apparatus 85 are aligned respectively with the ejection ports of the liquid transfer apparatuses 81 and 84.

An operation is conducted in a controlled manner firstly by introducing 1 μl of liquid from the liquid transfer apparatus 82 and 5 μl of liquid from the liquid transfer apparatus 83 into the liquid transfer apparatus 81. Subsequently, the introduced liquids are held in the containing section of the liquid transfer apparatus 81 at 30° C. for 30 seconds and then 50 μl of liquid is introduced from each of the liquid transfer apparatuses 81 and 84 into the liquid transfer apparatus 85. The liquid in the liquid transfer apparatus 84 is held to 30° C. and the liquid in the liquid transfer apparatus 85 is ejected by 5 μl at a time at every 20 seconds and diluted by a buffer solution to observe the absorption of light of 500 nm.

With this device, it is possible to observe the change with time of the activity of carnitine palmitoyl transferase in the liver of a rat by using only a minute amount of liquid.

1. A liquid transfer apparatus comprising:
a liquid containing section for containing liquid;
a liquid introducing section for introducing liquid into said liquid containing section; and
a liquid leading out section for leading out the liquid introduced into said liquid containing section,
characterized in that
said liquid introducing section and said liquid leading out section are arranged so as to make the liquid leading out section of a liquid transfer apparatus connected with the liquid introducing section of another liquid transfer apparatus.

2. A liquid transfer apparatus according to claim 1, characterized in that at least either said liquid introducing section or said liquid leading out section has a sealing material for maintaining a liquid-tightness when it is connected to the liquid leading out section or the liquid introducing section, whichever appropriate, of another liquid transfer apparatus.

3. A liquid transfer apparatus according to claim 1, characterized in that said liquid containing section has a processing means for heating, condensing, agitating, mixing or causing a chemical or biochemical reaction of the liquid introduced from said liquid introducing section.

4. A liquid transfer apparatus according to claim 1, characterized in that said liquid leading out section has a check valve.

5. A liquid transfer apparatus according to claim 1, characterized in that said liquid leading out section has an energy application means for applying energy necessary for ejecting liquid.

6. A liquid conveyor according to claim 1, characterized in that said liquid containing section has a plurality of liquid introducing sections and said liquid transfer apparatus further comprises means for mixing a first liquid introduced from one of the liquid introducing sections and a second liquid introduced from another one of the liquid introducing sections.

7. A liquid transfer apparatus according to claim 6, characterized in that the first and second liquids are a specimen and a solvent of the specimen.

8. A liquid transfer apparatus according to claim 7, characterized in that the specimen is a component of a living body.

9. A liquid transfer apparatus according to claim 6, characterized in that it further comprises analyzing means for analyzing a specific component contained in the mixture solution mixed by said mixing means.

10. A liquid transfer apparatus according to claim 9, characterized in that said analyzing means is detection means for detecting the specific component.

11. A liquid transfer method characterized by comprising:
a step of reversibly connecting to unite a plurality of liquid conveyors, each comprising a liquid containing section for containing liquid, a liquid introducing section for introducing liquid into said liquid containing section and a liquid leading out section for leading out the liquid introduced into said liquid containing section; and
a step of transferring liquid from the liquid introducing section of a liquid transfer apparatus to the liquid leading out section of another liquid transfer apparatus by ejecting the liquid contained in the liquid containing section of the former liquid transfer apparatus.
